(19) United States
(12) Patent Application Publication
(10) Pub. No.: US 2007/0153301 A1
(43) Pub. Date: Jul. 5, 2007

(54) Image magnification system and method thereof

(75) Inventors: Ching-Yen Chang, Hsinchu City (TW); Shuei-Lin Chen, Hsinchu City (TW); Chung-Ching Lin, Hsinchu City (TW)

Correspondence Address: BACON & THOMAS, PLLC, 625 SLATERS LANE, FOURTH FLOOR, ALEXANDRIA, VA, 22314, US

(73) Assignee: ALTEK CORPORATION, Hsinchu City (TW)

(21) Appl. No.: 11/452,334

(22) Filed: Jun. 14, 2006

(30) Foreign Application Priority Data
Dec. 30, 2005 (TW) 094147419

(51) Int. Cl. G06K 15/02

(52) U.S. Cl. 358/1.2; 358/1.9

(57) ABSTRACT

An image magnification system and method thereof for selectively perform either a low-rating magnification process or a high-rating magnification process for an image captured by a digital camera is disclosed. The method of the invention comprises the steps of: reducing the image to reduced image data, performing a pre-magnification process for the reduced image data to generate pre-magnified image data, and selectively perform either the lowing-rating magnification process for the reduced image data or the high-rating magnification process for the pre-magnified image data.

### BACKGROUND OF THE INVENTION

1. Field of the Invention

The present invention provides an image magnification system and method thereof for a digital camera, and more particularly, an image magnification system having a pre-magnification process module and method thereof for a digital camera.

2. Description of the Related Art

Generally speaking, when a digital camera performs motional or stationary image magnification, an image displaying module (e.g. LCD) must display a specific quantity of images per second in order to prevent the generation of noise signals and the effect of residual images. This requirement constrains an image capturing module (e.g. CCD), as it must output every row of the image to the image displaying module within a specific time frame.

As a result, in the image magnification process of precedent technologies, an image processing module must reserve a specific amount of bandwidth for the image magnification process, and a larger bandwidth reservation is required for a high-rating image magnification process. Throughout the duration of a motional image magnification process, the image processing module must increase the rate at which the motional images are processed in order to keep the number of images, which are transmitted from the image capturing module, to a minimum required quantity.

However, increasing the rate of the magnification process will cause the chip to encounter problems such as bandwidth insufficiency or clock frequency limitation. Thus throughout the duration of the motional image magnification process of precedent technologies, the number of images per second must be reduced to prevent bandwidth insufficiency and problems thereof.

At the same time, the digital camera's image processing system of precedent technologies uses a single-directional processing method, therefore every processing module must have sufficient bandwidth to allow the storage of processing data obtained from the previous module; however, this could easily results in bandwidth insufficiency for the image processing procedures, which further results in the generation of noise signals and effect of image residuals.

### SUMMARY OF THE INVENTION

In order to resolve the problems mentioned above, the present invention provides an image magnification system and method thereof, which can selectively perform a low-rating magnification process or a high-rating magnification process for an image, and also is able to reduce the system's bandwidth requirement.

The present invention of an image magnification system comprises of: an image capturing module for capturing an original image; an image reducing control module which reduces the original image by converting it into reduced image data; a pre-magnification module which performs a pre-magnification process on the reduced image data to generate pre-magnified image data, a magnification module for selectively magnifying either the reduced image data or the pre-magnified image data to ultimately generate magnified image data; a temporary image storage module for temporarily storing either the pre-magnified image data or the magnified image data; and an image displaying module that displays the magnified image data; wherein, when performing the low-rating magnification process, the magnification module magnifies the reduced image data; when performing the high-rating magnification process, the magnification module magnifies the pre-magnified image data.

The present invention also provides a method of image magnification which comprises the steps of: capturing an original image; reducing the original image by converting it into reduced image data; performing a pre-magnification process on the reduced image data to convert it into pre-magnified image data; selectively performing either a low-rating magnification process on the reduced image data or a high-rating magnification process on the pre-magnified image data to ultimately produce magnified image data; temporarily storing the magnified image data; and displaying the magnified image data.

Via the image magnification system and its method of the invention depicted above, the processing bandwidth requirement is reduced, and noise generation is prevented during the high-rating magnification process of a digital camera.

### BRIEF DESCRIPTION OF THE DRAWINGS

FIG. 1 is a structural block diagram of an image magnification system in accordance with the present invention.

FIG. 2 is a path diagram of a high-rating magnification process for an image magnification system in accordance with the present invention.

FIG. 3 is a path diagram of a low-rating magnification process for an image magnification system in accordance with the present invention.

FIG. 4 is a flow chart of a high-rating magnification process for an image magnification method in accordance with the present invention.

FIG. 5 is a flow chart of a low-rating magnification process for an image magnification method in accordance with the present invention.

### DETAILED DESCRIPTION OF THE PREFERRED EMBODIMENT

Other advantages and novel features of the invention will become more apparent from the following detailed description when taken in conjunction with the accompanying drawings.

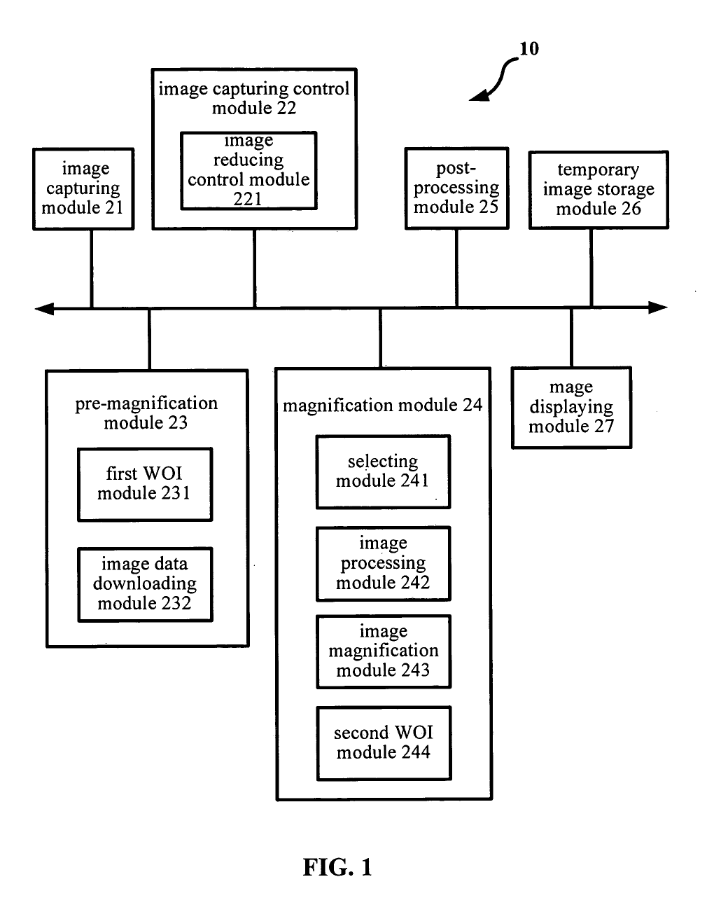

Please refer to FIG. 1, which shows a structural block diagram of an image magnification system for the present invention.

As indicated in FIG. 1, the image magnification system 10 comprises of the following modules which are electronically coupled with each other: an image capturing module 21, an image capturing control module 22, a pre-magnification module 23, a magnification module 24, a post-processing module 25, a temporary image storage module 26, and an image displaying module 27.

The image capturing module 21 is used for capturing an original image. The image capturing control module 22 controls the image capturing module 21, it also consists of an image reducing control module 221, which is used to convert the image into reduced image data. The pre-magnification module 23 is used to generate pre-magnified image data from the reduced image data through the pre-magnification process. The magnification module 24 is used to generate magnified image data from either reduced image data or pre-magnified image data through a selective magnification process. The post-processing module 25 is used to transmit the pre-magnified image data to magnification module 24. The temporary image storage module 26 is used for the storage of pre-magnified image data and/or magnified image data. And finally the image displaying module 27 is used to display the magnified image data.

In one exemplary embodiment of this invention, the image capturing module 21 can be a CCD, a CMOS or the like. The image capturing control module 22, the pre-magnification module 23, the magnification module 24, and the post-processing module 25 can be constructed through software, circuitry and/or hardware installation. Random access memory (RAM) is the preferred component for the temporary image storage module 26, but the present invention is not limited to this component. Liquid crystal display (LCD) is the preferred component for the image displaying module 27, but the present invention is not be limited to this component. The present invention can also perform motional or stationary image magnification.

Via the construction as shown in FIG. 1, the present invention is able to selectively perform either a low-rating magnification process or a high-rating magnification process for an image through the image magnification system 10; unlike the precedent technologies, the present invention also prevents the problem of bandwidth insufficiency during the high-rating magnification process. In the preferred embodiment, the low-rating magnification process achieves magnification of up to 4 times the original image size and the high-rating magnification process achieves magnification of at least 5 times the original image size.

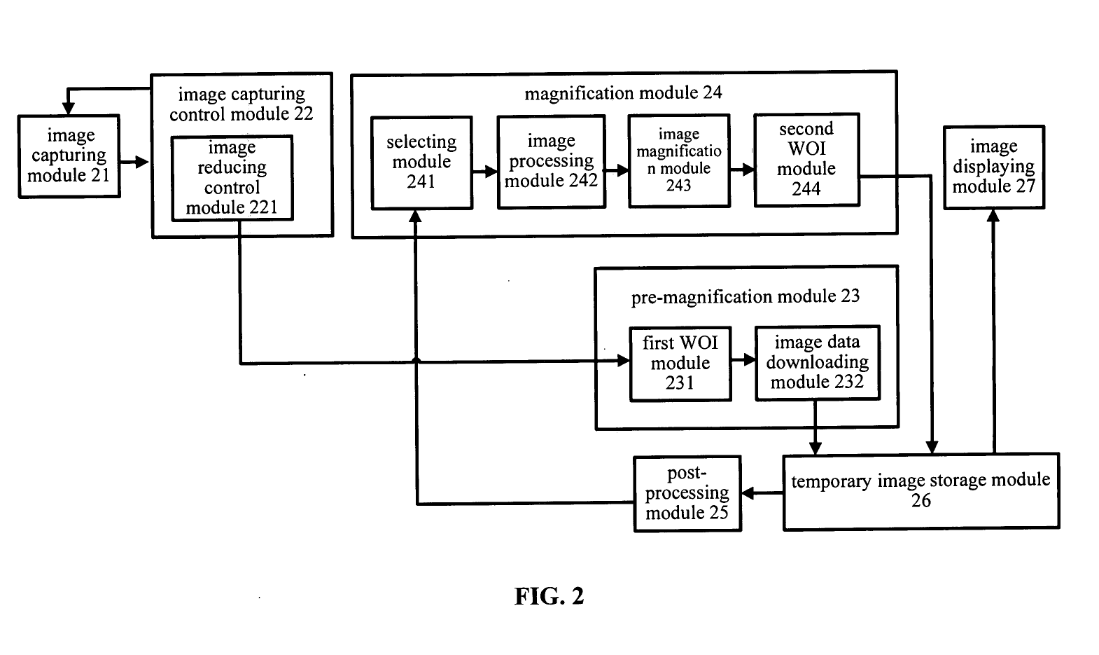

Please refer to FIG. 2 for the path diagram of a high-rating magnification process of the present invention.

As displayed in FIG. 2, in the duration of the high-rating magnification process, the present invention uses an image capturing control module 22 to transmit a control signal to an image capturing module 21, and the image capturing module 21 then captures an image and transmits its representing data to the image capturing control module 22. In one preferred embodiment of this invention, the image data is transferred to the image capturing control module 22 through a data bus (not shown in the figure).

Next, the Image capturing control module 22 reduces the image through the use of an image reducing control module 221 by converting it into reduced image data. Next, the reduced image data is transmitted to a pre-magnification module 23 for the execution of the pre-magnification process.

In the execution of the pre-magnification process of the pre-magnification module 23, the reduced image data is first transferred to the first Window of Interest (WOI) module 231, to provide it with a pre-determined area selected from the reduced image data defined by the user, and converting the pre-determined area into pre-magnified image data; next, an image data downloading module 232 downloads the pre-magnified image data to a temporary storage module 26 for temporary storage. A post-processing module 25 then transfers the pre-magnified image data to a magnification module 24 for the execution of the magnification process.

In the execution of the magnification process of the magnification module 24, the pre-magnified image data is first transferred to a selecting module 241, to provide it with the option for selecting a high-rating magnification process. Next, the pre-magnified image data is transferred to an image processing module 242 for the execution of related image processes such as hue, brightness or the like. After the image processing module 242 completes the related image processes, the pre-magnified image data is then transferred to an image magnification module 243 to provide it with the pre-magnified image data for magnification; the data is then converted into a magnified image data.

Next, a second Window of Interest module 244 of the present invention is used to select a pre-determined displaying area from the magnified image data, defined by the user, then the pre-determined displaying area is stored temporary in a temporary image storage module 26 and finally the pre-determined displaying area is displayed onto the image displaying module 27. Please note that in one exemplary embodiment of this invention, the second Window of Interest module 244 and the first Window of Interest module 231 may be implemented as a single module to reduce cost.

Thus, through the present invention, performing the high-rating image magnification process (especially in the motional images) differs from the precedent technologies which require decreasing the image refreshing rate during bandwidth insufficiency, causing the generation of noise signals and the effect residual images. Furthermore, the present invention not only offers the high-rating magnification process that achieves magnification of at least 5 times the original image size, but also offers a low-rating magnification process that achieves magnification of up to 4 times the original image size.

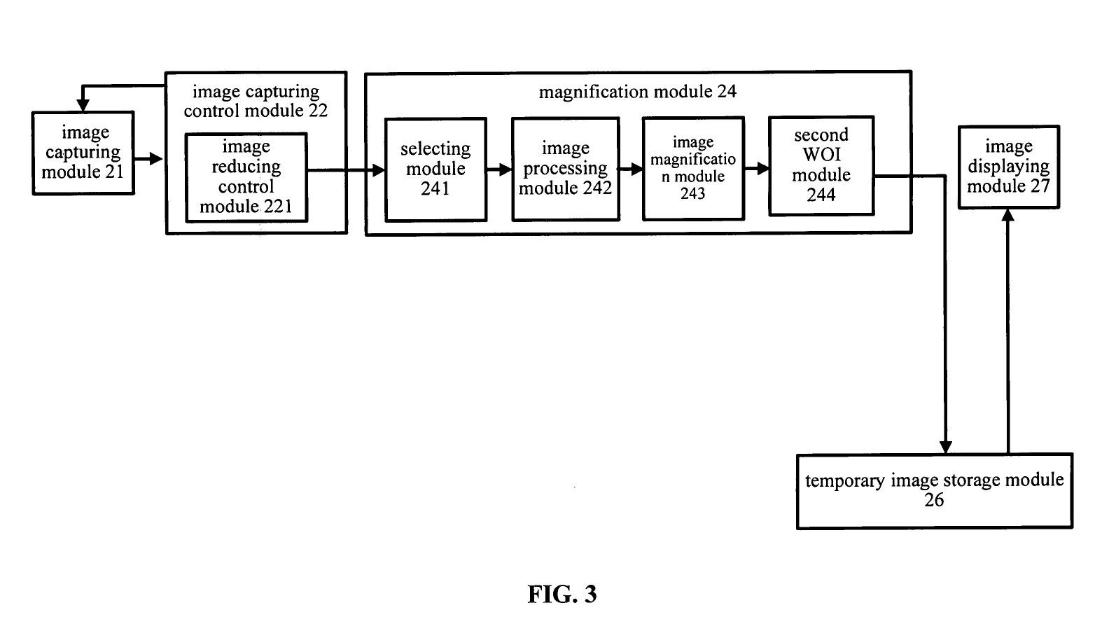

Please refer to FIG. 3 for the path diagram of a low-rating magnification process of the present invention.

As displayed in FIG. 3, in the duration of the low-rating magnification process, the present invention uses an image capturing control module 22 to transmit the control signal to an image capturing module 21, the image capturing module 21 captures an image and transmits its representing data to the image capturing control module 22. Similarly, in one preferred embodiment of this invention, the image data is transferred to the image capturing control module 22 through a data bus (not shown in the figure).

Next, the image capturing control module 22 reduces the image through an image reducing control module 221 by converting it into reduced image data. Next, the reduced image data is transmitted to a magnification module 24 for the execution of the magnification process.

In the execution of the pre-magnification process of the magnification module 24, the reduced image data is first transferred to a selecting module 241, to provide it with the option of selecting the low-rating magnification process. Next, the reduced image data is transferred to an image processing module 242 for the execution of related image processes such as hue, brightness or the like. After the image processing module 242 completes the related image processes, the reduced image data is then transferred to a magnification module 243, to provide it with the reduced image data for magnification; the data is then convert into the magnified image data.

Next, a second Window of Interest module 244 of the present invention is used to select a pre-determined displaying area from the magnified image data, defined by the user, then the pre-determined displaying area is stored temporary in a temporary image storage module 26 and finally the pre-determined displaying area is displayed onto a displaying module 27.

Thus, as displayed in FIG. 2 and FIG. 3, the selecting module 241 of the present invention enables the selection of pre-magnification image data or reduced image data for the execution of the high-rating magnification process or low-rating magnification process respectively.

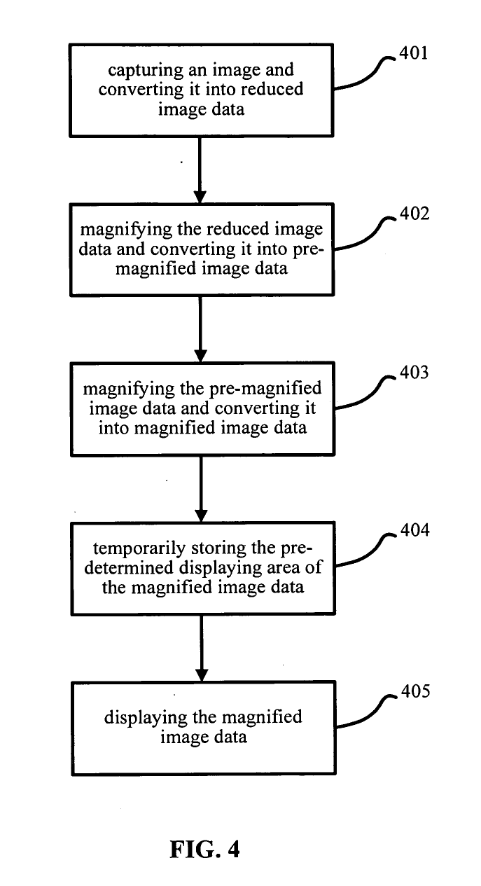

Next, please refer to FIG. 4 for the flow chart of a high-rating magnification process for the image magnification method in accordance with the present invention.

As displayed in FIG. 4, first, the present invention performs procedure 401, which captures an image and converts it into reduced image data.

Next, the present invention pre-magnifies the reduced image data via procedure 402. Procedure 402 of the present invention first selects a pre-determined magnifying area from the reduced image data defined by the user and converting it into pre-magnified image data; the pre-magnified image data is then downloaded for temporary storage and the downloaded pre-magnified image data is then transmitted.

Please note that the process of downloading pre-magnified image data and the process of transmitting the downloaded pre-magnified image data can be performed concurrently. In other words, the present invention enables the transmission of the downloaded data as soon as it is downloaded, and does not require waiting for the pre-magnified image data to be downloaded completely. This saves system bandwidth utilization and accelerates the processing time.

Next, the present invention magnifies the pre-magnified image data via procedure 403. Procedure 403 of the present invention first is set to receive the pre-magnified image data, and then executes the related image processes, and then it magnifies the pre-magnified image data turning it into the final magnified image data. The pre-determined displaying area defined by the user is then selected from the magnified image data.

Next, the present invention continues with procedure 404, which temporarily stores the pre-determined displaying area obtained from the magnified image data, and the pre-determined displaying area is then displayed via procedure 405.

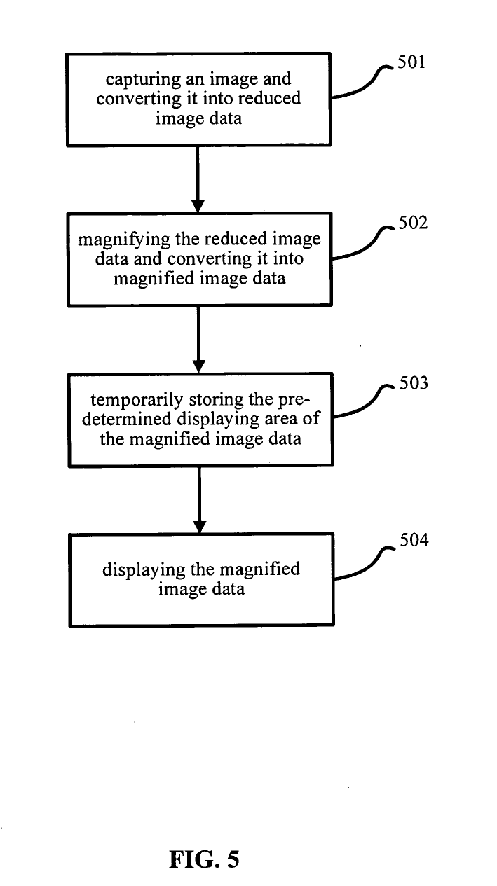

Finally, please refer to FIG. 5 for the flow chart of a low-rating magnification process for the image magnification method in accordance with the present invention.

As displayed in FIG. 5, first the present invention performs procedure 501, which captures an image and converts it into reduced image data.

Next, the present invention magnifies the reduced image data via procedure 502. Procedure 502 of the present invention first is set to receive the reduced image data, and then executes the related image processes, and then it magnifies the reduced image data turning it into the final magnified image data.

Next, the present invention proceeds with procedure 503, which temporarily stores the pre-determined displaying area obtained from the magnified image data, and the pre-determined displaying area is then displayed via procedure 504.

Thus, as displayed in FIG. 4 and FIG. 5, depending on the selection, the present invention is able to perform either the high-rating magnification or the low-rating magnification, for pre-magnification image data or reduced image data respectively.

Although the present invention has been explained in relation to its preferred embodiment, it is to be understood that many other possible modifications and variations can be made without departing from the spirit and scope of the invention as hereinafter claimed.

What is claimed is:

1. An image magnification system, which can selectively perform a low-rating magnification process or a high-rating magnification process for an image captured by a digital camera, the image magnification system comprising:
an image capturing module for capturing an original image;
an image reducing control module which reduces the original image by converting it into reduced image data;
a pre-magnification module which performs a pre-magnification process on the reduced image data to generate pre-magnified image data;
a magnification module for selectively magnifying the reduced image data or the pre-magnified image data to ultimately generate magnified image data;
a temporary image storage module for temporarily storing the pre-magnified image data or the magnified image data;
an image displaying module that displays the magnified image data; wherein, when performing the low-rating magnification process, the magnification module magnifies the reduced image data; when performing the high-rating magnification process, the magnification module magnifies the pre-magnified image data; and the image capturing module, the image reducing control module, the pre-magnification module, the magnification module, the image displaying module and the temporary image storage module are electronically coupled with each other.

2. The image magnification system as claimed in claim 1, wherein the pre-magnification module comprises:
a first window of interest (WOI) module used for selecting a predetermined area from the reduced image data, and converting the selected pre-determined area of the reduced image data into the pre-magnified image data; and
an image data downloading module which is electronically coupled with the first WOI for downloading the pre-magnified image data to the temporary image storage module.

3. The image magnification system as claimed in claim 1, wherein the magnification module comprises:
a selection module enabling the selection for magnifying the reduced image data or the pre-magnified image data;
an image magnification module capable of generating magnified images for the reduced image data or the pre-magnified image data; and
a second WOI module for selecting a predetermined displaying area from the magnified image data, and transmitting the predetermined displaying area of the magnified image data to the temporary image storage module to be displayed by the image displaying module; wherein, the selection module, the image magnification module and the second WOI module are electronically coupled with each other.

4. The image magnification system as claimed in claim 1 further comprising: a post-processing module which is electronically coupled with the temporary image storage module for the transmission of the pre-magnified image data to the magnification module.

5. The image magnification system as claimed in claim 1, wherein the low-rating magnification process achieves image magnification of substantially up to 4 times the original image.

6. The image magnification system as claimed in claim 1, wherein the high-rating magnification process achieves image magnification of substantially at least 5 times the original image.

7. An image magnification method for selectively perform a low-rating magnification process or a high-rating magnification process for an image captured by a digital camera, the method comprising the following steps:
capturing an original image;
reducing the original image by converting it into reduced image data; performing a pre-magnification process on the reduced image data to convert it into pre-magnified image data;
selectively performing the low-rating magnification process for the reduced image data or the high-rating magnification process for the pre-magnified image data to ultimately produce magnified image data; temporarily storing the magnified image data; and
displaying the magnified image data.

8. The image magnification method as claimed in claim 7 further comprising the following steps:
selecting a predetermined area from the reduced image data to convert it into the pre-magnified image data; and
downloading the pre-magnified image data for temporary storage.

9. The image magnification method as claimed in claim 7 further comprising the following step:
selecting a predetermined area from the magnified image data.

10. The image magnification method as claimed in claim 7, wherein the low-rating magnification process achieves image magnification of substantially up to 4 times the original image.

11. The image magnification method as claimed in claim 7, wherein the high-rating magnification process achieves image magnification of substantially at least 5 times the original image.
